(19) United States
(12) Patent Application Publication
(10) Pub. No.: US 2004/0122667 A1
(43) Pub. Date: Jun. 24, 2004

(54) Voice activity detector and voice activity detection method using complex laplacian model

(76) Inventors: Mi-Suk Lee, Daejeon-city (KR); Dae-Hwan Hwang, Daejeon-city (KR); Joon-Hyuk Chang, Seoul (KR); Nam-Soo Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/699,126

(22) Filed: Oct. 30, 2003

(30) Foreign Application Priority Data
Dec. 24, 2002 (KR) 2002-83728

(51) Int. Cl. G10L 15/00

(52) U.S. Cl. 704/233

(57) ABSTRACT

Disclosed is a voice activity detector using a complex Laplacian statistic module, the voice activity detector including: a fast Fourier transformer for performing a fast Fourier transform on input speech to analyze speech signals of a time domain in a frequency domain; a noise power estimator for estimating a power of noise signals from noisy speech of the frequency domain output from the fast Fourier transformer; and a likelihood ratio test (LRT) calculator for calculating a decision rule of voice activity detection (VAD) from the estimated power of noise signals from the noise power estimator and a complex Laplacian probabilistic statistical model.

### CROSS REFERENCE TO RELATED APPLICATION

This application claims priority to and the benefit of Korea Patent Application No. 2002-83728 filed on Dec. 24, 2002 in the Korean Intellectual Property Office, the content of which is incorporated herein by reference.

### BACKGROUND OF THE INVENTION

(a) Field of the Invention

The present invention relates to a voice activity detector and a voice activity detection method. More specifically, the present invention relates to a voice activity detector and a voice activity detection method using a complex Laplacian model.

(b) Description of the Related Art

Variable rate transmission technology is required in many wideband speech codecs specified in the 3GPP/3GPP2 standard. For variable rate transmission, a speech codec must employ a voice activity detector that allocates fewer bits in the case of no voice. Namely, voice activity detection (VAD) technology is considered an indispensable factor to variable rate coding and noise enhancement technologies.

Recently, many algorithms have been suggested to improve the performance of VAD algorithms for separating noisy speech into noise and speech. One of these methods is the spectral irregularity measure-based model holding that the spectrum of speech changes faster than that of noise. However, this model may extremely deteriorate the performance of the system when a noise having the same spectrum of speech is included.

Another algorithm for improving the performance of the VAD using a statistical model is disclosed in the paper entitled “A statistical model-based voice activity detection”, IEEE Signal Processing Letters, Vol. 6, No. 1 pp1-3, January 1999 by J. Sohn, N. S. Kim and W. Sung (Reference 1). The model of this paper derives a decision rule for VAD from a likelihood ratio test (LRT) that is applied to a set of hypotheses.

The conventional VAD algorithms, which primarily operate in the discrete Fourier transform (DFT) domain, employ the spectral distribution of clean speech and noise as defined by the complex Gaussian density.

However, the modeling of DFT coefficients for clean speech and noise using the complex Gaussian distribution is, to some degree, limited in accuracy, so there is a need for a new distribution model for DFT coefficients.

### SUMMARY OF THE INVENTION

It is an advantage of the present invention to provide a voice activity detector and a voice activity detection method using a complex Laplacian model, and to compare the performance between a Laplacian model and a Gaussian model.

In one aspect of the present invention, there is provided a voice activity detector using a complex Laplacian statistic module that includes: a fast frequency Fourier transformer for performing a fast Fourier transform on input speech to analyze speech signals of a time domain in a frequency domain; a noise power estimator for estimating a power λ_{n,k}(t) of noise signals from noisy speech X(k) of the frequency domain output from the fast Fourier transformer; and a likelihood ratio test (LRT) calculator for calculating a decision rule of voice activity detection (VAD) from the estimated power λ_{n,k}(t) of noise signals from the noise power estimator and a complex Laplacian probabilistic statistical model.

In another aspect of the present invention, there is provided a voice activity detection method using a complex Laplacian statistic module that includes: (a) performing a fast Fourier transform on input speech, and generating noisy speech X(k) to analyze speech signals of a time domain in a frequency domain; (b) estimating a power in λ_{n,k}(t) of noise signals from the noisy speech X(k) of the frequency domain output in the step (a); and (c) calculating a decision rule of VAD from the estimated power λ_{n,k}(t) of noisy signals and a complex Laplacian probabilistic statistical model.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a curve comparing the Laplacian cumulative density function and the Gaussian cumulative density function of a speech spectrum with an empirical cumulative density function;

FIG. 2 is an illustration showing the receiver operational characteristic of voice activity detectors using the Laplacian model and the Gaussian model, respectively; and

FIG. 3 is a schematic of a voice activity detector according to an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

The embodiment of the present invention proposes a complex Laplacian model to apply DFT coefficients of noisy speech signals to VAD in different noise conditions.

First, the embodiment of the present invention applies a GOF (Goodness of Fit) test to noisy speech in different noise conditions to compare a Laplacian model with a Gaussian model, and then considers a decision rule based on the LRT (Likelihood Ratio Test).

1. Statistical Model

Assuming that the sum of noise signal X(t) and speech signal S(t) is X(t), hypothesis H₀ represents the absence of speech, and hypothesis H₁ represents the presence of speech. Namely, X(t) meets the following equations 1 and 2 in the hypotheses H₀ and H₁, respectively.

H₀:speech absent:X(t)=N(t) Equation 1

H₁:speech present:X(t)=N(t)+S(t) Equation 2

where X(t)=[X₀(t), X₁(t), . . . , X_{M-1}(t)]^{T} N(t)=[N₀(t), N₁(t), . . . , N_{M-1}(t)]^{T} and S(t)=[S₀(t), S₁(t), . . . , S_{M-1}(t)]^{T} are DFT coefficients of noisy speech, noise, and clean speech, respectively.

The statistical model is completed by the selection of an appropriate distribution of DFT coefficients. In the embodiment of the present invention, a complex Laplacian PDF (Probabilistic Density Function) rather than the Gaussian PDF is adapted as an appropriate distribution of DFT coefficients.

In the complex Gaussian PDF, the distribution of noisy spectral components determined by the hypotheses H₀ and H₁ is defined as the following equations 3 and 4, respectively.

$$\begin{matrix}{p}_{G} ( {X}_{k} / {H}_{0} ) = \frac{1}{{πλ}_{n , k}} exp \{ - \frac{{\vert {X}_{k} \vert}^{2}}{{λ}_{n , k}} \} & Equation 3 \\ {p}_{G} ( {X}_{k} / {H}_{1} ) = \frac{1}{π [ {λ}_{n , k} + {λ}_{s , k} ]} exp \{ - \frac{{\vert {X}_{k} \vert}^{2}}{{λ}_{n , k} + {λ}_{s , k}} \} & Equation 4\end{matrix}$$

where λ_{n,k} and λ_{s,k} are the variances of noise Nₖ and clean speech Sₖ, respectively.

In the complex Laplacian PDF, a real part X_{k(R)} and an imaginary part Xₖ₍ₗ₎ of the DFT coefficient Xₖ are distributed according to the equations 5 and 6, respectively.

$$\begin{matrix}p ( {X}_{k ( R )} ) = \frac{1}{{σ}_{x}} exp \{ - \frac{2 \vert {X}_{k ( R )} \vert}{{σ}_{x}} \} & Equation 5 \\ p ( {X}_{k ( l )} ) = \frac{1}{{σ}_{x}} exp \{ - \frac{2 \vert {X}_{k ( l )} \vert}{{σ}_{x}} \} & Equation 6\end{matrix}$$

where σₓ² is the variance of Xₖ. Assuming that the real part is independent of the imaginary part in Xₖ, the PDF p(Xₖ) can be determined as the equation 7.

$$p ( {X}_{k} ) = p ( {X}_{k ( R )} ) \cdot p ( {X}_{k , ( l )} ) = \frac{1}{{σ}_{x}^{2}} exp \{ - \frac{2 ( \vert {X}_{k ( R )} \vert + \vert {X}_{k ( l )} \vert )}{{σ}_{x}} \} \qquad Equation 7$$

By using the equation 7, the distribution of the noise DFT coefficients can be determined as the equations 8 and 9.

$$\begin{matrix}{p}_{L} ( {X}_{k} / {H}_{0} ) = \frac{1}{{λ}_{n , k}} exp \{ - \frac{2 ( \vert {X}_{k ( R )} \vert + \vert {X}_{k ( l )} \vert )}{\sqrt{{λ}_{n , x}}} \} & Equation 8 \\ {p}_{L} ( {X}_{k} / {H}_{1} ) = \frac{1}{{λ}_{n , k} + {λ}_{s , k}} exp \{ - \frac{2 ( \vert {X}_{k ( R )} \vert + \vert {X}_{k ( l )} \vert )}{\sqrt{{λ}_{n , x} + {λ}_{s , k}}} \} & Equation 9\end{matrix}$$

For a successful VAD operation, the embodiment of the present invention performs a statistical fitting test for the noise spectral components determined by H₀ and H₁.

For selection of the PDF, the embodiment of the present invention adopts the Kolomogorov-Sriminov (KS) test that is well known as a GOF test. The use of the KS test guarantees a reliable observation for each statistical hypothesis.

The KS test involves the comparison of an empirical cumulative distribution function (CDF) Fx and a defined distribution function F. The empirical CDF as used herein is disclosed in the paper entitled “Distributions of the two dimensional DCT coefficients for images”, IEEE Trans. Communications., Vol. Com-31, No. 6, June 1983 by R. C. Reininger and D. Gibson (Reference 2).

Assuming that the vector representing the DFT coefficients of noisy speech is X=[X₀, X₁, . . . , X_{N-1}]^{T}, the empirical CDF based on the paper can be expressed by the equation 10.

$${F}_{X} ( z ) = \{ \begin{matrix}0 , & z < {X}_{( 1 )} & \\ \frac{n}{N} , & {X}_{( n )} \leq z < {X}_{( n + 1 )} , & n = 0 , 1 , ⋯ , N - 1 \\ 1 , & z \geq {X}_{( N )} & \end{matrix} \qquad Equation 10$$

where X₍ₙ₎ (n=0, . . . , N−1) is the order statistic of data X. For computation of this order statistic, the embodiment of the present invention classifies the elements of data X to arrange the elements in the order from smallest X₍₀₎ to largest X_{(N-1)}.

For a simulation of the noise environment, the speech materials of 64-second intervals were collected from four male talkers and four female talkers, and white noise and vehicular noise extracted from the NOISEX-92 database were added to the clean speech signals having a signal-to-noise ratio (SNR) of 10 dB. The sample means and the sample variance of the collected data were calculated and applied to a given Laplacian/Gaussian distribution.

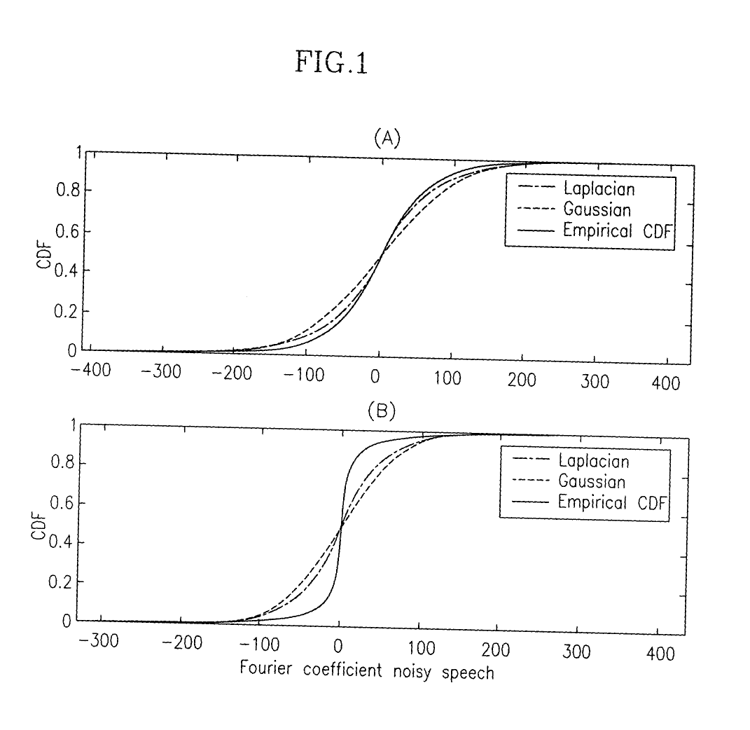

FIG. 1 is a graph showing the comparison of the Laplacian/Gaussian CDF of the noisy speech spectrum (real part) and the empirical CDF, where H₁ represents white noise (SNR=10 dB) in (a) and vehicular noise (SNR=20 dB) in (b).

As can be seen from FIG. 1, the Laplacian curve is closer to the empirical CDF curve than the Gaussian CDF curve in both the white noise and vehicular noise environments.

To specify the distance measurement between the empirical CDF and the given distribution, the embodiment of the present invention uses the KS test statistic of the Reference 2.

The KS test statistic T is defined by the following equation 11.

$$T = {max}_{i} \vert {F}_{X} ( {X}_{i} ) - F ( {X}_{i} ) \vert \qquad Equation 11$$

Here, the maximum difference between F_{X}(Xᵢ) and F(Xᵢ) determined at a sample point {Xᵢ} corresponds to the distance.

In the test of data for several distributions, the distribution of the minimum KS statistic is considered most suitable for the given data. The results of the KS test for the DFT coefficients of noisy speech in various noise environments are presented in Table 1, where G and L represent Gaussian distribution and Laplacian distribution, respectively.

TABLE 1

| | | noise | | | | | | | | |
|---|---|---|---|---|---|---|---|---|---|---|
| | | white | | | vehicular | | | babble | | |
| SNR (dB) | | 5 | 10 | 15 | 5 | 10 | 15 | 5 | 10 | 15 |
| H₁ | G; X_{k(R)} | 0.043 | 0.078 | 0.129 | 0.211 | 0.223 | 0.231 | 0.129 | 0.165 | 0.198 |
| | L; X_{k(R)} | 0.031 | 0.025 | 0.068 | 0.164 | 0.177 | 0.186 | 0.071 | 0.107 | 0.145 |
| | G; X_{k(I)} | 0.044 | 0.081 | 0.134 | 0.214 | 0.225 | 0.232 | 0.142 | 0.173 | 0.203 |
| | L; X_{k(I)} | 0.028 | 0.026 | 0.073 | 0.164 | 0.178 | 0.187 | 0.080 | 0.116 | 0.149 |
| H₀ | G; X_{k(R)} | 0.045 | 0.052 | 0.063 | 0.238 | 0.270 | 0.311 | 0.149 | 0.127 | 0.136 |
| | L; X_{k(R)} | 0.024 | 0.024 | 0.023 | 0.189 | 0.237 | 0.277 | 0.088 | 0.167 | 0.078 |
| | G; X_{k(I)} | 0.051 | 0.059 | 0.071 | 0.243 | 0.275 | 0.325 | 0.153 | 0.127 | 0.134 |
| | L; X_{k(I)} | 0.019 | 0.016 | 0.021 | 0.243 | 0.237 | 0.278 | 0.093 | 0.067 | 0.075 |

It can be seen from Table 1 that the KS statistic T of the Laplacian model is less than that of the Gaussian model in all the noise environments. Accordingly, the Laplacian model is much more accurate than the Gaussian model in modeling the DFT coefficients.

2. LRT-Based Decision Rule

In the embodiment of the present invention, the likelihood ratio (LR) for the k-th frequency bin is calculated based on the assumed statistical model according to the equation 12.

$${Λ}_{k} ≡ \frac{p ⟨ {X}_{k} \vert {H}_{1} ⟩}{p ⟨ {X}_{k} \vert {H}_{0} ⟩} \qquad Equation 12$$

The decision rule for the VAD can be defined as the geometric average of the LR for each frequency channel, and is expressed by the equation 13.

$$log Λ = \frac{1}{M} {\sum }_{k = 0}^{M - 1} log {Λ}_{k} \begin{matrix}{{H}_{1}}_{>} \\ {{H}_{0}}^{<}\end{matrix} η \qquad Equation 13$$

where η is the threshold value for the decision.

In the conventional Gaussian distribution for H₀ and H₁, the LR is determined according to the equation 14.

$${Λ}_{k}^{( G )} ≡ \frac{{p}_{G} ⟨ {X}_{k} \vert {H}_{1} ⟩}{{p}_{G} ⟨ {X}_{k} \vert {H}_{0} ⟩} = \frac{1}{1 + {ξ}_{k}} exp \{ \frac{{γ}_{k} {ξ}_{k}}{1 + {ξ}_{k}} \} \qquad Equation 14$$

where ξₖ=λ_{s,k}/λ_{n,k} and γₖ=|Xₖ|²/λₙ.

The LR calculated based on the Laplacian model is given by the equation 15.

$${Λ}_{k}^{( L )} ≡ \frac{{p}_{L} ⟨ {X}_{k} \vert {H}_{1} ⟩}{{p}_{L} ⟨ {X}_{k} \vert {H}_{0} ⟩} = \frac{1}{1 + {ξ}_{k}} exp \{ 2 ( \vert {X}_{k ( R )} \vert + \vert {X}_{k ( l )} \vert ) ( \frac{\vert {X}_{k} \vert - \sqrt{{λ}_{n , x}}}{\vert {X}_{k} \vert \sqrt{{λ}_{n , x}}} ) \} \qquad Equation 15$$

Here, the success or failure of the VAD is decided by an appropriate estimation for noise power {λ_{n,k}(t)} and speech power {λ_{s,k}(t)} as well as the statistical model.

3. Simulation Result

To compare the performance between Laplacian and Gaussian models, the embodiment of the present invention analyzes speech detection probability P_{d} and false-alarm probability P_{f} for each statistical model.

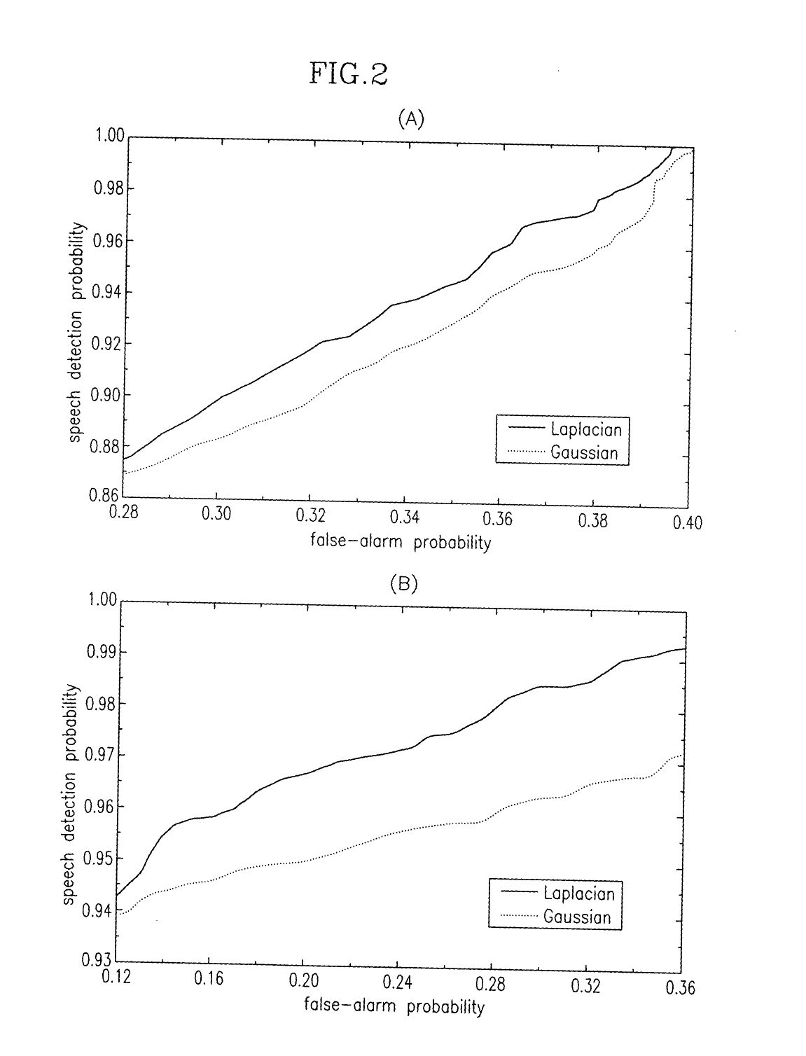

FIG. 2 is a graph showing the receiver operational characteristic of the VAD using Laplacian and Gaussian models at an SNR of 5 dB, where (a) and (b) show the cases of white noise and vehicular noise, respectively. In the graph of FIG. 2, the ordinate and abscissa are speech detection probability P_{d} and false-alarm probability P_{f}, respectively.

As can be seen from the receiver operational characteristic of FIG. 2, there exists a trade-off between P_{d} and P_{f} of the two statistical models, and the decision rule based on the complex Laplacian model is preferable to that based on the complex Gaussian model when the speech detection probability P_{d} is in a normal range (greater than 90%).

As described above, the VAD based on the complex Laplacian model is superior in performance to that based on the complex Gaussian model in various noise environments.

Next, a description will be given as to a voice activity detector employing the complex Laplacian model according to an embodiment of the present invention.

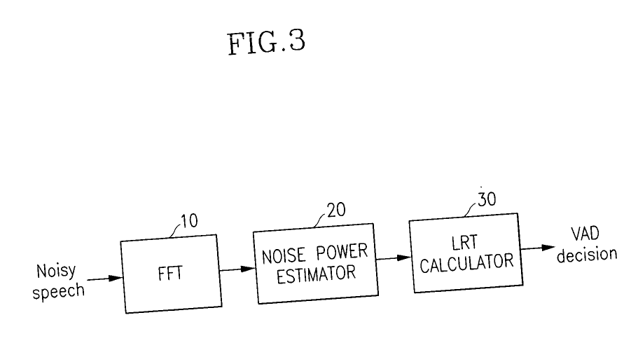

FIG. 3 is an illustration of the voice activity detector according to the embodiment of the present invention.

The voice activity detector according to the embodiment of the present invention comprises, as shown in FIG. 3, a fast Fourier transformer (FFT) 10, a noise power estimator 20, and an LRT calculator 30.

The FFT 10 performs a fast Fourier transform on input speech and outputs noisy speech X(k) so as to analyze speech signals in the frequency domain. The noise power estimator 20 estimates the power of noise signals from the noisy speech X(k) in the frequency domain output from the FFT 10. The LRT calculator 30 calculates the decision rule of the VAD from the power λ_{n,k}(t) of the noise signal estimated from the noise power estimator 20 and the complex Laplacian probabilistic statistical model for the defined existence hypotheses H₀ and H₁ of the speech signal.

The decision rule is, as described previously, defined as a geometric average of the LR for each frequency channel, and the LR of the Laplacian model is expressed by the equation 15.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the VAD of the present invention uses the Laplacian statistic distribution and hence has better performance than the VAD based on the complex Gaussian model.

What is claimed is:

1. A voice activity detector using a complex Laplacian statistic module, comprising:
a fast frequency Fourier transformer for performing a fast Fourier transform on input speech to analyze speech signals of a time domain in a frequency domain;
a noise power estimator for estimating a power λ_{n,k}(t) of noise signals from noisy speech X(k) of the frequency domain output from the fast frequency Fourier transformer; and
a likelihood ratio test (LRT) calculator for calculating a decision rule of voice activity detection (VAD) from the estimated power λ_{n,k}(t) of noise signals from the noise power estimator and a complex Laplacian probabilistic statistical model.

2. The voice activity detector as claimed in claim 1, wherein the decision rule is a geometrical average of likelihood ratio Λₖ for the k-th frequency, the likelihood ratio Λₖ being determined by the following equation:
$${Λ}_{k} ≡ \frac{p ⟨ {X}_{k} \vert {H}_{1} ⟩}{p ⟨ {X}_{k} \vert {H}_{0} ⟩}$$
wherein hypothesis H₀ represents the case of absence of speech; hypothesis H₁ represents the case of presence of speech; and Xₖ is the k-th discrete Fourier coefficient.

3. The voice activity detector as claimed in claim 2, wherein the likelihood ratio using the Laplacian statistic module is determined by the following equation:
$${Λ}_{k}^{( L )} ≡ \frac{{p}_{L} ⟨ {X}_{k} \vert {H}_{1} ⟩}{{p}_{L} ⟨ {X}_{k} \vert {H}_{0} ⟩} = \frac{1}{1 + {ξ}_{k}} exp \{ 2 ( \vert {X}_{k ( R )} \vert + \vert {X}_{k ( I )} \vert ) ( \frac{\vert {X}_{k} \vert - \sqrt{{λ}_{n , k}}}{\vert {X}_{k} \vert \sqrt{{λ}_{n , k}}} ) \}$$
wherein ξₖ=λ_{s,k}/λ_{n,k}; and X_{k(R)} and Xₖ₍ₗ₎ are a real part and an imaginary part of Xₖ, respectively.

4. A voice activity detection method using a complex Laplacian statistic module, comprising:
(a) performing a fast Fourier transform on input speech, and generating noisy speech X(k) to analyze speech signals of a time domain in a frequency domain;
(b) estimating a power λ_{n,k}(t) of noise signals from the noisy speech X(k) of the frequency domain output in the step (a); and
(c) calculating a decision rule of VAD from the estimated power λ_{n,k}(t) of noisy signals and a complex Laplacian probabilistic statistical model.

5. The voice activity detection method as claimed in claim 4, wherein the decision rule is a geometrical average of a likelihood ratio for the k-th frequency, the likelihood ratio being determined by the following equation:
$${Λ}_{k}^{( L )} ≡ \frac{{p}_{L} ⟨ {X}_{k} \vert {H}_{1} ⟩}{{p}_{L} ⟨ {X}_{k} \vert {H}_{0} ⟩} = \frac{1}{1 + {ξ}_{k}} exp \{ 2 ( \vert {X}_{k ( R )} \vert + \vert {X}_{k ( I )} \vert ) ( \frac{\vert {X}_{k} \vert - \sqrt{{λ}_{n , k}}}{\vert {X}_{k} \vert \sqrt{{λ}_{n , k}}} ) \}$$
wherein hypothesis H₀ represents the case of absence of speech; hypothesis H₁ represents the case of presence of speech; Xₖ is the k-th discrete Fourier coefficient; λₖ=λ_{s,k}/λ_{n,k}; and X_{k(R)} and Xₖ₍ₗ₎ are a real part and an imaginary part of Xₖ, respectively.
